(19) United States
(12) Patent Application Publication
(10) Pub. No.: US 2008/0111336 A1
(43) Pub. Date: May 15, 2008

(54) Suspended Axle For a Vehicle

(76) Inventors: Francis Aubarede, Pontgibaud (FR); Bruno Guimard, Chatel-Guyon (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/793,174

(22) PCT Filed: Dec. 16, 2005
(86) PCT No.: PCT/EP05/56842

§ 371 Date: Jun. 14, 2007

(30) Foreign Application Priority Data
Dec. 22, 2004 (FR) 0413787

(51) Int. Cl. B60G 21/05; B60G 7/00

(52) U.S. Cl. 280/124.128; 280/124.134

(57) ABSTRACT

A suspended axle for a vehicle comprising, for each wheel (2), a longitudinal arm (5) intended to be articulated with respect to the body of the vehicle so as to allow the wheel its suspension travel, said axle comprising a transverse torsion element (10), each end (11) of the transverse torsion element being rigidly connected to a longitudinal arm to form a rigid part (12) of the axle, the two rigid parts of the axle being joined together by a torsion part (13). The axle comprises for each wheel, a hub carrier (3) connected to a respective one of the rigid parts. Each hub carrier is connected to the respective rigid part by means of a front link (7) and a rear link (9), the connections between the hub carrier and the front and rear links and the connections between the front and rear links and the rigid part constituting substantially vertical pivots (14), the axle being configured in such a way as to define a degree of freedom for the wheel to steer with respect to the rigid part about a substantially vertical steering axis (AB) and intersecting the ground on the outside and to the rear of the wheelbase (BR).

The present invention relates to the connection between motor vehicles and the ground, and in particular relates to suspension and wheel-support devices, more especially the rear axles of touring vehicles (passenger cars).

The term “ground connection” covers all the elements and functions present, active or involved in the relationship between the body of the vehicle and the ground over which the latter moves. Thus the following elements in particular form part of the ground connection: the tires, the wheels, the wheel bearings, the hub carriers, the braking components, suspension elements (links, wishbones, struts, etc), springs, dampers, joints, anti-vibration components, anti-roll, anti-lock, anti-wheel spin systems, steering systems and course control systems.

Suspension devices have two main functions that have to be performed simultaneously and at all times throughout operation. One of these functions is that of suspending the vehicle, that is to say of allowing each wheel substantially vertical oscillations according to the load applied to that wheel. The other function of these devices is that of guiding the wheel, that is to say of controlling the angular position of the wheel plane.

The “wheel plane” is the term used to describe the plane, associated with the wheel, which is perpendicular to the axis of the wheel and which passes through the center of the area of static contact with the ground when the wheel is vertical. The wheel plane thus defined is therefore integral with the wheel axis and its orientation varies with that of the wheel.

The angular position of the wheel plane with respect to the body of the vehicle is defined by two angles: the camber angle and the steering angle. The camber angle of a wheel is the angle, in a transverse plane perpendicular to the ground, between the wheel plane and the mid plane of the vehicle. The steering angle of a wheel is the angle, in a horizontal plane parallel to the ground, between the wheel plane and the mid plane of the vehicle.

The “wheelbase” is the term used to describe the point of intersection between the wheel plane, the plane of the ground and the vertical plane containing the axis of the wheel.

In the field of motor vehicles, a wide variety of suspension systems have been proposed, particularly for suspending the rear wheels. It is currently accepted that axles known as “multiple-link” axles allow good performance to be obtained in terms of steering, suspension and vibration filtering. However, these axles are relatively complicated and use a great many parts and points of connection to the body. Hence, they are bulky, intrusive and expensive, and this is why they are not very widely used on small or medium-sized vehicles, in spite of the dynamic qualities that they are recognized to possess.

It is one objective of the invention to propose a rear axle that allows at least some of the aforementioned disadvantages to be alleviated.

This object is achieved through a suspended axle for a vehicle comprising, for each wheel, a longitudinal arm intended to be articulated with respect to the body of the vehicle so as to allow the wheel its suspension travel, said axle comprising a transverse torsion element, each end of the transverse torsion element being rigidly connected to a longitudinal arm to form a rigid part of the axle, the two rigid parts of the axle being joined together by a torsion part, said axle comprising, for each wheel, a hub carrier connected to a respective one of the rigid parts, the axle being characterized in that each hub carrier is connected to the respective rigid part by means of a front link and a rear link, the connections between the hub carrier and the front and rear links and the connections between the front and rear links and the rigid part constituting substantially vertical pivots, the axle being configured in such a way as to define a degree of freedom for the wheel to steer with respect to the rigid part about a substantially vertical steering axis and intersecting the ground on the outside and to the rear of the wheelbase.

Preferably, at least one of the pivot connections of the front or rear links comprises an elastic means giving said pivot connection rotational stiffness. Preferably, said pivot connection consists of an elastomeric joint.

According to a variant, at least one of the pivot connections of the front or rear links comprises a flexible plate, preferably made of steel.

Preferably, the length of the torsion part of the transverse torsion element is greater than one-third of the track of the axle.

According to a preferred embodiment of the axle, the transverse torsion element comprises a first tube secured to a first longitudinal arm and a second tube secured to a second longitudinal arm, the first tube being at least partially inserted inside the second tube, the two tubes being guided in rotation relative to one another. In this case, the rear links are preferably connected to the tubes near the join in the transverse torsion element.

Preferably, the transverse length of the rear link is greater than 20% of the track of the axle.

Preferably, the axle further comprises a suspension spring acting between the body and the hub carrier and more preferably still, the axle further comprises a suspension damper, also acting between the body and the hub carrier.

Preferably, the axle further comprises active control means for actively controlling the steering movement of the wheel with respect to the rigid part.

Preferably, when the vehicle is carrying its rated load, the steering axis is inclined toward the rear of the vehicle by an angle ranging between 0° and 30°, preferably between 0° and 20°, and more preferably still, between 5° and 10°.

Preferably, the front links are oriented in such a way as to make an angle of less than 60°, preferably less than 50°, with the longitudinal direction of the vehicle.

The invention also relates to a motor vehicle comprising said axle.

The invention will be better understood by virtue of the description of the figures which respectively depict:

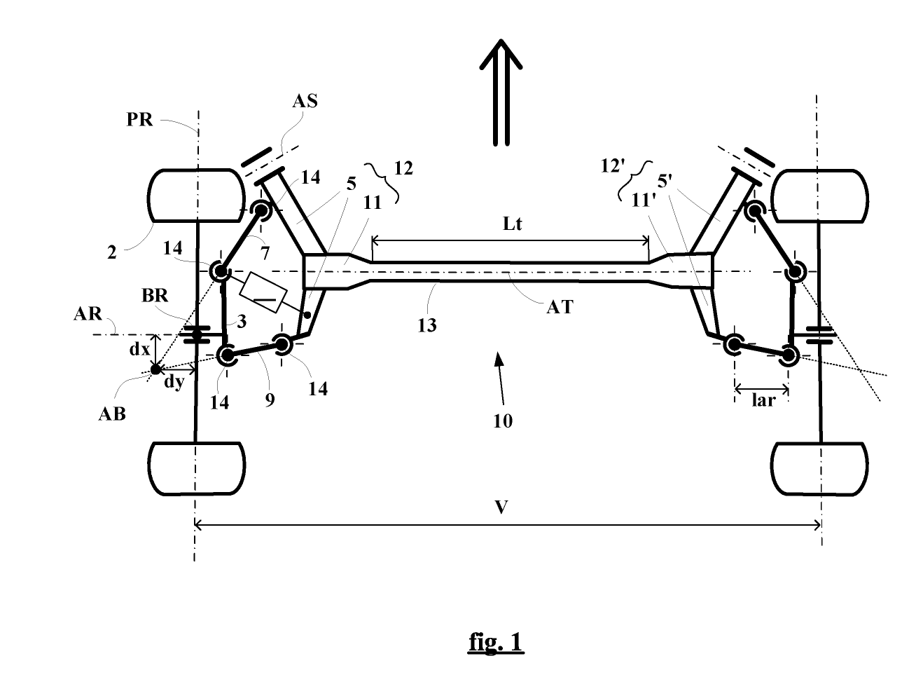

FIG. 1: a schematic view from above of a first embodiment of an axle according to the invention;

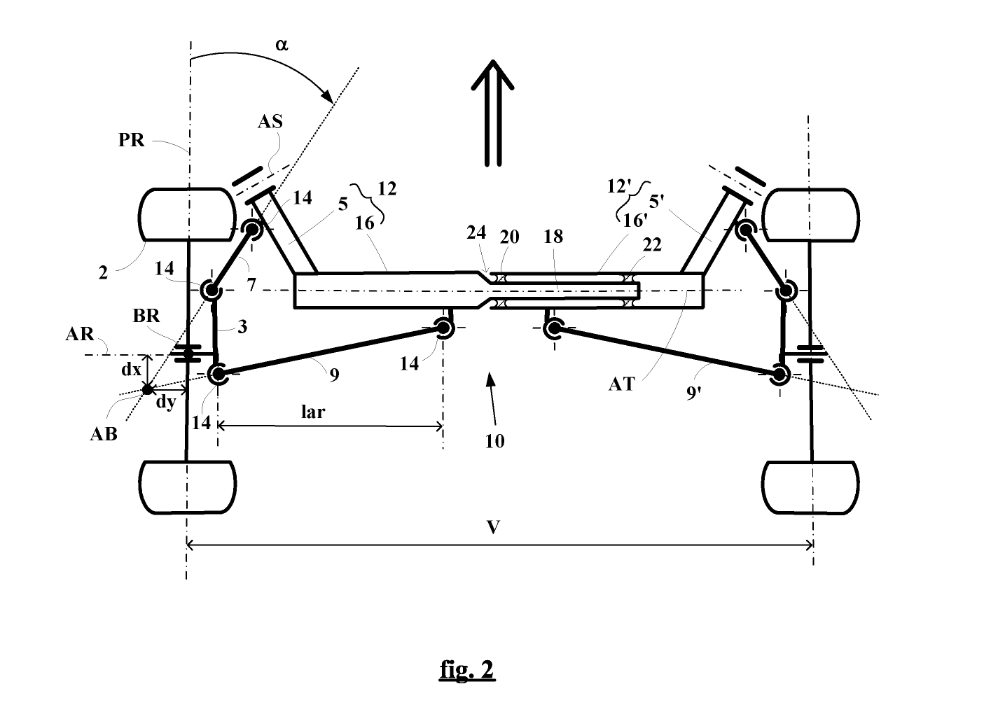

FIG. 2: a schematic view from above of a second embodiment of an axle according to the invention;

FIG. 3: a schematic view from above of a third embodiment of an axle according to the invention;

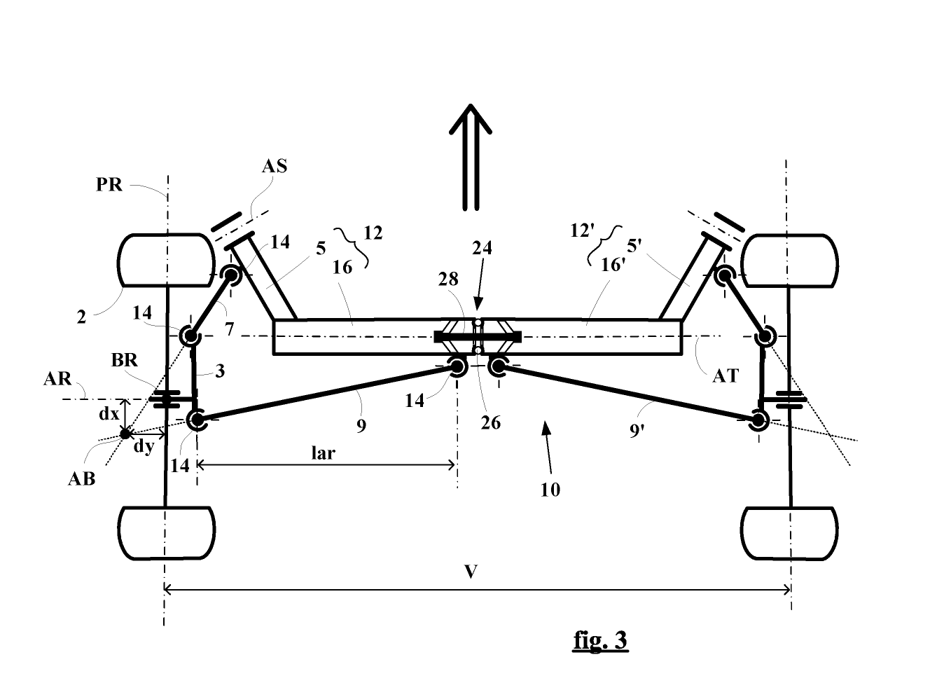

FIG. 4: a schematic view from above of a variant of the first embodiment depicted in FIG. 1;

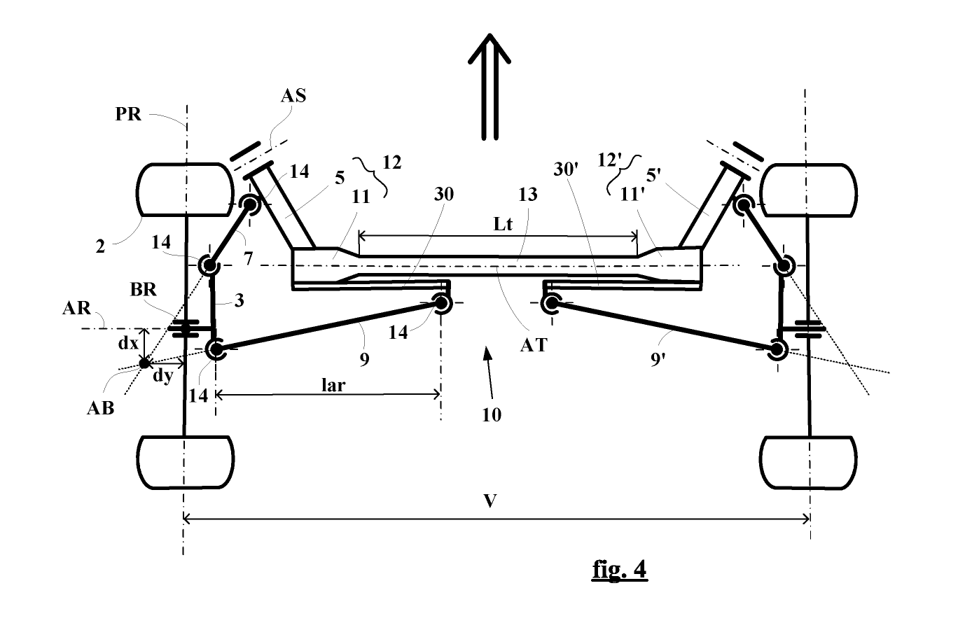

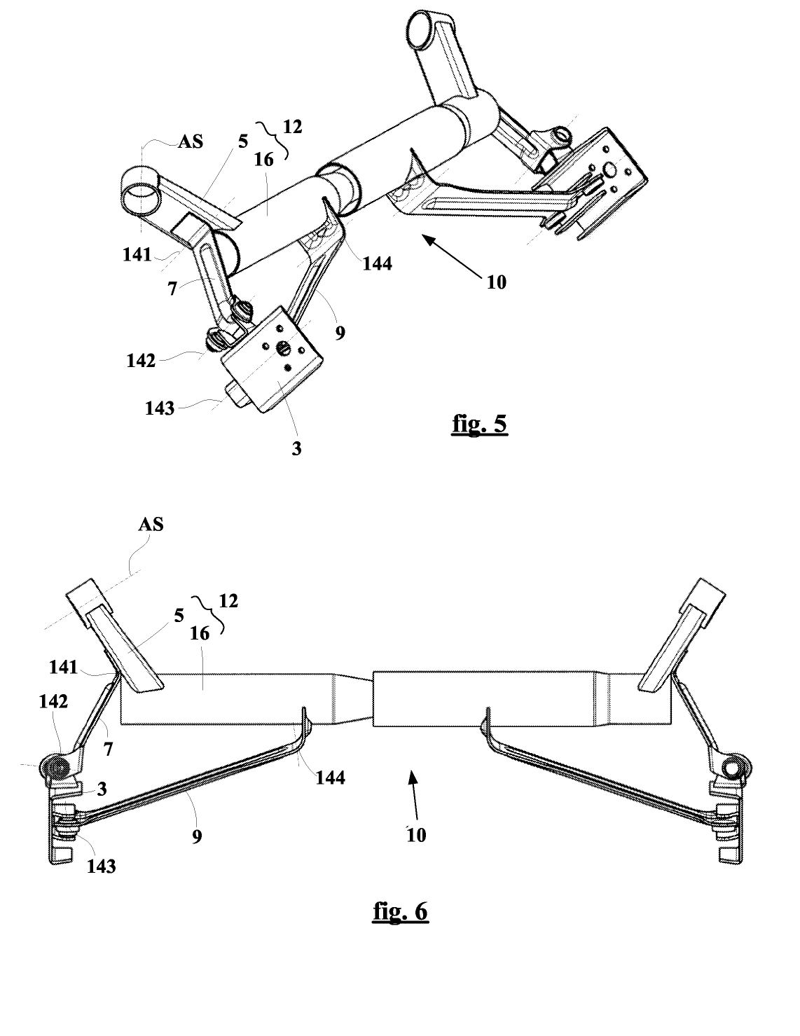

FIG. 5: a perspective view of an example of an axle according to a second embodiment of the invention;

FIG. 6: a view from above of the example of FIG. 5;

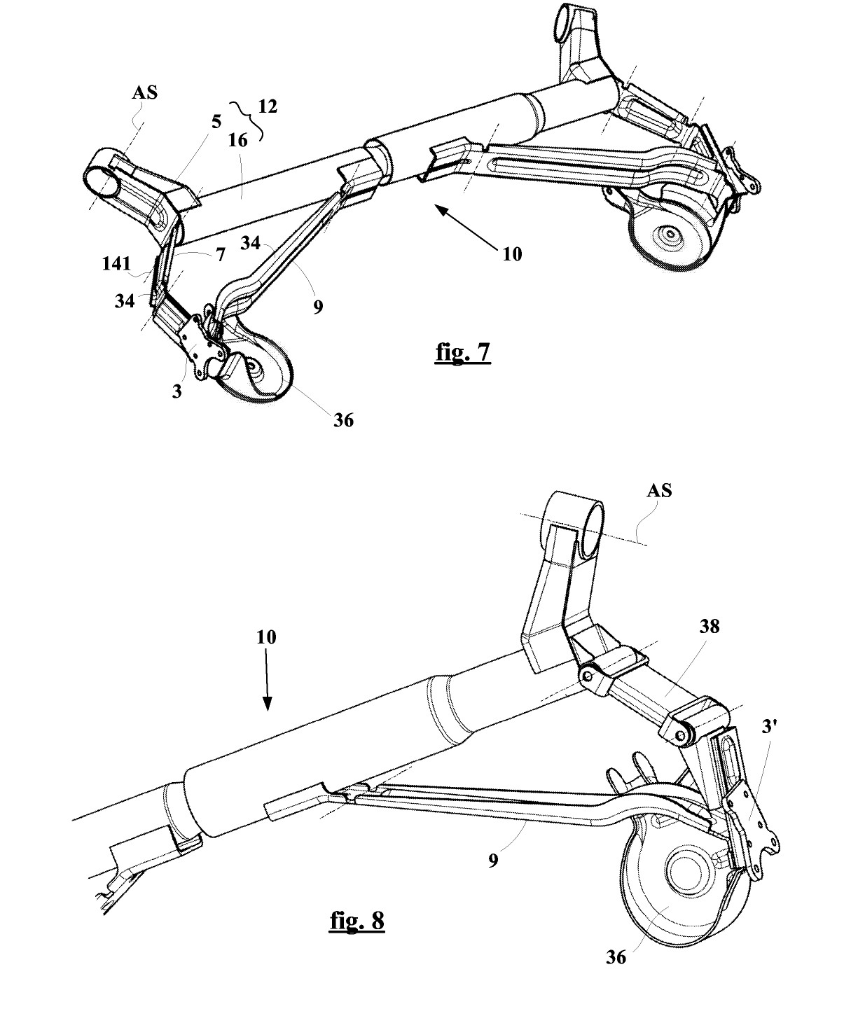

FIG. 7: a perspective view of a second example of an axle according to the second embodiment of the invention;

FIG. 8: a perspective part view of a third example of an axle according to the second embodiment of the invention.

In the various figures, elements which are identical or similar bear the same reference numerals. They are not therefore systematically described repeatedly.

FIG. 1 schematically depicts a view from above of a first embodiment of a rear axle according to the invention. The ground is parallel to the plane of the drawing and the front of the vehicle is at the top of the figure. As the axle is substantially symmetric, its description is based chiefly on the left-hand part thereof.

The axle comprises, for each wheel, a longitudinal arm 5 intended to be articulated with respect to the body of the vehicle (not depicted) by means of an articulation of axis AS so as to allow the wheel 2 its suspension travel. A transverse torsion element 10 connects the two longitudinal arms 5 and 5′. Each end 11, 11′ of the transverse torsion element is rigidly connected to the corresponding longitudinal arm (the term “embedded” is also used). The assembly comprising the longitudinal arm 5 and the rigid end 11 of the transverse torsion element constitutes a rigid part 12. This rigid part is connected to the other rigid part 12′ of the axle by a torsion part 13 of the transverse torsion element so as to allow the two wheels of the axle a different travel. The transverse torsion element contributes predominantly to guiding the wheel planes, particularly as far as camber is concerned. In addition, the transverse torsion element provides the axle with anti-roll stiffness dependent in particular on the torsional rigidity of its torsion part. One significant feature of the transverse torsion element is its torsion length “Lt”.

The wheel axis AR is connected to the hub carrier 3. the hub carrier is articulated with respect to the rigid part 12 by means of a front link 7 and a rear link 9. The connections constitute substantially vertical pivots 14. The front 7 and rear 9 links and their connections are configured in such a way as to allow the hub carrier 3 (and therefore the wheel 2) a certain degree of freedom for steering with respect to the rigid part 12 about a substantially vertical steering axis AB situated outside the wheel plane PR and to the rear of the wheel axis AR. In this view from above, the wheelbase BR appears at the intersection between the mid plane PR of the wheel and the wheel axis AR. The intersection between the steering axis AB and the ground lies a distance “dx” to the rear of the wheelbase and a distance “dy” outside the wheelbase. For a compact passenger car, distances dx and dy of the order of 100 mm give satisfactory results.

The pivots 14 may be produced in different ways, for example using plain bearings, ball, roller or needle bearings, or elastomeric joints. The pivots may also be based on the flexing of a flat profile as will be seen later. The most suitable technique for each link can be selected according to the anticipated angles of rotation and loadings.

The term “track of the axle” is generally given to the distance (V) between the two wheel planes at ground level. In a way known per se, in order to guarantee satisfactory durability for a reasonable weight, the torsion length Lt for this type of transverse torsion element is preferably greater than one third of the track of the axle, or even greater than half.

This figure clearly shows one principle of the invention whereby, on the one hand, the suspension travel of each wheel is given by the oscillation of the corresponding longitudinal arm and, on the other hand, the relative movements of the front and rear links allow essentially steering movements of the wheel relative to the corresponding longitudinal arm.

In order to adapt the steering movements to suit the forces exerted by the ground on the wheel, the axle may comprise an elastic means that provides stiffness that opposes the steering movement. The axle according to the invention can thus operate purely passively as a function, for example, of the braking forces and transverse forces exerted in a bend. The elastic means may be incorporated into the pivot connections or into just some of these. For purely passive operation, pivot stiffness of the order of 100 N.m per degree may be needed in order to obtain satisfactory behavior. Naturally, this elastic return of the steering by the pivots may be exerted (evenly or unevenly) by all the pivots of the axle or by a limited number of them.

The axle may also comprise active control means for actively controlling the steering. This option is depicted schematically in the figure in the form of an actuator 15. The active steering control means may in practice adopt any form that allows them to be operated as a function of vehicle running parameters. In the case of active control, elastic return of the steering by an elastic means may be reduced or eliminated. Likewise, the distances dy and dx may be reduced by comparison with an axle in which the operation is purely passive.

The active control means can be operated as a function of various vehicle running parameters (for example speed, longitudinal or transverse acceleration, braking force, steering wheel position, rate at which the steering wheel is being turned, moment exerted on the steering wheel, roll, roll rate, roll acceleration, yaw, yaw rate, yaw acceleration, loadings on the wheels including the vertical load, driving style or behavior desired by the driver).

The actuator 15 may equally be a simple telescopic damper, that is to say a passive means of controlling the “natural” steering movements of each hub carrier.

FIG. 2 depicts an advantageous embodiment of the invention in which the transverse torsion element 10 employs the principles described in patents EP 0904211, EP 1265763 or international application WO02/2238497. This type of transverse torsion element chiefly employs two coaxial tubes. A first tube (the left-hand tube in this example) comprises a part 18 the cross section of which is reduced by comparison with that of the second tube in order to allow this reduced part of the first tube to be inserted in the second tube (the right-hand tube in this example). The two tubes may for example be guided relative to one another by elastic bushings 20 and 22. Torsional deformations of the transverse torsion element caused by the rolling of the body are therefore absorbed by the elastic connection between the two tubes. The torsion part of the transverse torsion element therefore here lies inside the rigid part (in this instance the right-hand rigid part 12′). As a result of this, in the context of the present invention, the rigid parts 12 and 12′ may extend practically as far as the join 24 between the two transverse torsion element halves 16 and 16′. In this embodiment, it is then possible (and this may prove particularly advantageous) to give the rear links 9 and 9′ a long length (lar) by articulating them to the transverse torsion element halves near the join. One consequence of this longer length of the rear links may be greater stability of the position of the steering axis AB.

FIG. 3 depicts another embodiment of the invention in which the transverse torsion element 10 employs the principles described in patent application FR 2840561. This type of transverse torsion element employs two coaxial tubes 16 and 16′. At the join 24 between the tubes, the tension of a bar 28 holds a ball bearing 26 under pressure so as to provide coaxial guidance of the transverse torsion element halves 16 and 16′. The bar 28 also works in torsion in order to offer resistance to relative rotations of the tubes, that is to say torsion in the transverse torsion element 10. The rigid parts 12 and 12′ therefore here too also extend as far as the join between the two transverse torsion element halves because the torsion part of the transverse torsion element is positioned inside the tubes.

FIG. 4 schematically depicts one particular embodiment of the invention that combines a transverse torsion element 10 similar to that of FIG. 1 with rear link lengths (lar) comparable with those of FIGS. 2 and 3. To achieve this, the rigid parts 12 and 12′ are extended by offsetting pieces 30 and 30′. Thus, the length of the rear links 9 and 9′ is no longer restricted by the short transverse length of the rigid parts, the short rigid parts being typical of a monobloc transverse torsion element.

FIGS. 5 to 9 show exemplary embodiments of axles according to the invention. These embodiment examples are based on the use of a transverse torsion element involving two coaxial tubes guided in rotation one inside the other as described above with reference to FIG. 2. Naturally, as has been seen, other types of transverse torsion element may be used.

The axle in FIGS. 5 and 6 uses front and rear links made of steel plate, for example pressed steel plate. The pivot 141 between the front link 7 and the longitudinal arm 5 is produced by the flexing of a limited region of the plate. The front link is connected to the hub carrier 3 by a pair of elastomeric joints positioned in such a way as to define a pivot axis 142. Likewise, the pivot 144 between the rear link 9 and the transverse torsion element half 16 is produced by the flexing of a limited region of the plate of the link. The connection between the rear link and the hub carrier employs a pair of elastomeric joints positioned in such a way as to define a pivot axis 143.

Ribs are pressed into the plate of the links 7 and 9 in order to give the links the required rigidity outside of the regions that are intended to flex. It will be understood that the flexible regions make it possible to achieve the necessary pivoting and also make it possible to incorporate the elastic means able to offer stiffness to oppose the steering movement and which is therefore useful in control as described above. The elastomeric joints may also afford such stiffness.

The example in FIG. 7 is similar to that of FIGS. 5 and 6. However, this axle differs from the previous one in that all the pivots of the front and rear links are achieved by the flexing of the plate of the links. The rigidity of the links is enhanced by the use of a profile which, in addition to the pressed ribs, comprises raised lateral parts 34. Here, the hub carrier 3 comprises a support 36 intended to accept the end of a suspension coil spring (not depicted). The rear arm 9 is shaped in such a way as to allow such a spring to pass and to move. The support 36 may also accept the bottom eye of a telescopic suspension damper.

Naturally, the suspension spring may be of any other type, for example pneumatic, elastomeric, or a leaf spring.

The various elements in this variant (transverse torsion element, link, hub carrier) may all be assembled by welding. One benefit of an axle, such as this is of course the reduced number of components and the lower industrial cost.

FIG. 8 shows an axle similar to that of FIG. 7 except that the front link 38 here has a tubular profile and is articulated at both ends by way of elastomeric bearings.

The various figures show the longitudinal arm being articulated with respect to the body about horizontal axes. Other orientations are of course applicable; articulations with vertical axes may make industrial-scale assembly of the axle with the body easier. In addition, the axis of these articulations is depicted as being inclined with respect to the transverse direction of the vehicle as is known per se with a view to creating a steering effect in the longitudinal arms. However, since the invention allows the wheels to steer independently of the steering of the longitudinal arms, a steering effect in the longitudinal arms is therefore not absolutely essential and articulations that are not inclined may prove preferable in terms of comfort. Preferably, the axis of the transverse torsion element (AT in the figures) is offset toward the rear of the axle with respect to the articulations between the longitudinal arms and the body as has been depicted, but this is not essential to the invention.

The invention makes it possible to produce axles that are not overly complicated and in which the elasto-kinematic performance is highly beneficial. For example, it has been possible according to the invention to obtain a variation in toe-in under longitudinal loading (under braking) in excess of 0.05 degree per kiloNewton (°/kN), a variation in toe-in under transverse loading in excess of 0.1°/kN and a variation in camber under transverse loading of less than 0.5°/kN.

According to the invention, the steering axis AB is substantially vertical. In practice, its orientation varies with the suspension travel, that is to say with the oscillations of the longitudinal arms of the axle. When the vehicle is bearing its rated load, that is to say when it is in running order (with the fuel tank full) and carrying two passengers seated in the front seats, the steering axis AB is preferably inclined toward the rear of the vehicle, for example by an angle ranging between 0° and 30°, more preferably between 0° and 20°, and more preferably still, between 5° and 10°. Thus, the transverse loadings may also cause advantageous variations in camber. When it is said that the axis is inclined toward the rear, that means for example that, in the case of a left-hand wheel, viewed from outside the vehicle, the axis AB is inclined by the angle indicated in the clockwise direction with respect to the vertical.

According to another preferred feature of the invention, the front links (referenced 7 and 7′ in the figures) are oriented in such a way as to form an angle α of less than 60°, more preferably less than 50°, with the longitudinal direction of the vehicle. This preferred feature is depicted in FIG. 2 but of course also relates to all of the embodiments of the invention.

1. A suspended axle for a vehicle comprising, for each wheel (2), a longitudinal arm (5) intended to be articulated with respect to the body of the vehicle so as to allow the wheel its suspension travel, said axle comprising a transverse torsion element (10), each end (11) of the transverse torsion element being rigidly connected to a longitudinal arm to form a rigid part (12) of the axle, the two rigid parts of the axle being joined together by a torsion part (13), said axle comprising, for each wheel, a hub carrier (3) connected to a respective one of the rigid parts, the axle being characterized in that each hub carrier is connected to the respective rigid part by means of a front link (7) and a rear link (9), the connections between the hub carrier and the front and rear links and the connections between the front and rear links and the rigid part constituting substantially vertical pivots (14), the axle being configured in such a way as to define a degree of freedom for the wheel to steer with respect to the rigid part about a substantially vertical steering axis (AB) and intersecting the ground on the outside and to the rear of the wheelbase (BR).

2. The axle as claimed in claim 1, in which at least one of the pivot connections of the front or rear links comprises an elastic means giving said pivot connection rotational stiffness.

3. The axle as claimed in claim 2, in which said pivot connection consists of an elastomeric joint.

4. The axle as claimed in claim 2, in which at least one of the pivot connections (141) of the front or rear links comprises a flexible plate, preferably made of steel.

5. The axle as claimed in claim 1, in which the length of the torsion part (Lt) of the transverse torsion element is greater than one third of the track (V) of the axle.

6. The axle as claimed in claim 1, in which the transverse torsion element comprises a first tube secured to a first longitudinal arm and a second tube secured to a second longitudinal arm, the first tube being at least partially inserted inside the second tube, the two tubes being guided in rotation relative to one another.

7. The axle as claimed in claim 6, in which the rear links are connected to the tubes near the join (24) in the transverse torsion element.

8. The axle as claimed in claim 1, in which the transverse length of the rear link (lar) is greater than 20% of the track of the axle.

9. The axle as claimed in claim 1, further comprising a suspension spring acting between the body and the hub carrier.

10. The axle as claimed in claim 1, further comprising a suspension damper acting between the body and the hub carrier.

11. The axle as claimed in claim 1, further comprising active control means (15) for actively controlling the steering movement of the wheel with respect to the rigid part.

12. The axle as claimed in claim 1, in which, when the vehicle is carrying its rated load, the steering axis (AB) is inclined toward the rear of the vehicle by an angle ranging between 0° and 30°, preferably between 0° and 20°, and more preferably still, between 5° and 10°.

13. The axle as claimed in claim 1, in which the front links (7, 7′) are oriented in such a way as to make an angle (α) of less than 60°, preferably less than 50°, with the longitudinal direction of the vehicle.
